(19) United States
(12) Patent Application Publication
(10) Pub. No.: US 2011/0241242 A1
(43) Pub. Date: Oct. 6, 2011

(54) Plastic film

(75) Inventors: Walter Guenter, Forchheim (DE); Thomas Ihde, Forchheim (DE)

(73) Assignee: Húhtamaki Forchheim Zweigniederlassung der Huhtamaki Deutschland GmbH & Co. KG, Forchheim (DE)

(21) Appl. No.: 13/134,535

(22) Filed: Jun. 9, 2011

Related U.S. Application Data
(62) Division of application No. 11/059,958, filed on Feb. 17, 2005, now abandoned.
Application No. 11/059,958 is a division of application No. 10/129,686, filed on Aug. 20, 2002, now abandoned.

(30) Foreign Application Priority Data
Nov. 8, 1999 (DE) 19 953 707.0

(51) Int. Cl. B29D 7/01

(52) U.S. Cl. 264/45.8

(57) ABSTRACT

Plastic sheeting with a rough surface to increase the coefficient of friction, whereby at least one side of the sheeting is equipped with a layer (2, 22, 32), which layer contains the rough surface. This surface can be produced either by the coextrusion process or the coating method, and may also be provided on both sides.

The invention concerns a plastic sheeting with a rough surface to increase the coefficient of friction.

Such sheeting is known in practice, whereby a granular filler is usually already mixed into the plastic.

However, this causes the sheeting itself to be equipped with only limited strength and the roughness is also low.

It is the task of the invention to develop a sheeting of the said type in such a way as to achieve a very good surface roughness without impairing the strength of the sheeting.

This task is solved according to the invention in that at least one side of the sheeting is equipped with a layer containing the rough surface.

Owing to the separation of the carrier layer and the layer with a rough surface, both can be optimally designed.

It has proved extremely advantageous if, according to an advantageous embodiment of the invention, the actual sheeting and the layer or layers equipped with the rough surface are produced by the coextrusion process.

A rational production of the sheeting is thereby guaranteed despite the separate effects on the layers.

One advantageous embodiment of the invention lies in the fact that at least one of the layers equipped with the rough surface contains a propellant which produces gas bubbles immediately after leaving the coextrusion nozzle, which gas bubbles despoil the layer in such a way that an irregularly rough surface is created.

Such an embodiment has proved very advantageous.

According to a further embodiment of the invention, it is, however, also possible that at least one of the layers producing the rough surface is applied by the coating method.

A completely separate embodiment of the layer is also made possible thereby.

A very advantageous further embodiment of the invention is characterized in that the coating material consists of a binder and a filler.

According to a further embodiment of the invention, the filler is equipped with a granular structure and consists in particular of corundum and/or silica sand.

According to a further advantageous embodiment of the invention, the particle size of the filler lies in the range between 40 and 250 μm.

An advantageous further embodiment of the invention is characterized in that the filler is present in a striated structure following the application.

There are various options for producing the striated structure; all that must be ensured is that the application is of a drawing nature.

According to the invention, however, it is also possible for the filler to be present on the finished product in a branched, so-called ramified, structure.

A very good anti-slip behavior of the sheeting is achieved, both with the striated structure and with the ramified structure.

It has also proved very advantageous if, according to an advantageous further development of the invention, the application weight of the binder with the filler is approximately 5 to 50 g/m².

It is very beneficial here if the proportion of filler is approximately 20 to 70% of the application weight.

The invention will be further described with reference to three examples of embodiments shown in the drawing, whereby:

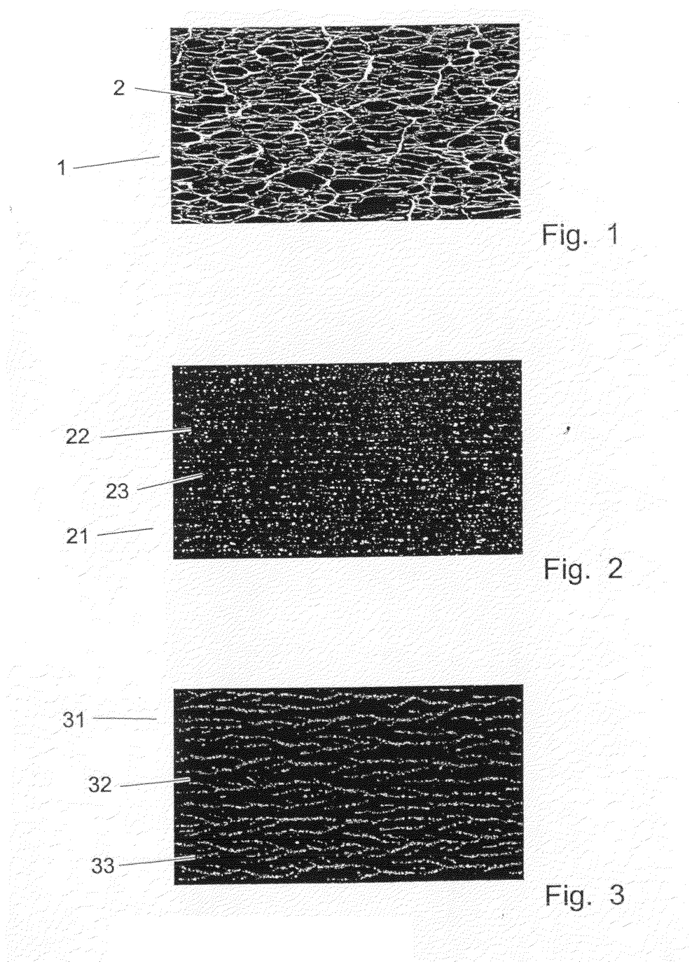

FIG. 1 shows a plan view of a plastic sheeting which is produced together with a top layer by the coextrusion process and which is equipped with largely torn surface.

FIG. 2 shows a plan view of a plastic sheeting with a striated application of a granular filler

FIG. 3 shows a plan view of a further plastic sheeting with filler in a ramified form.

The 1 in FIG. 1 designates a plastic sheeting which consists of a base sheeting, not described in greater detail, and a surface layer 2 coextruded with it. This surface layer 2 consists of a polyolefine, for example high-density polyethylene or polypropylene, in which a propellant is dissolved, which propellant foams when pressure is released on expulsion of the sheeting from the coextrusion nozzle, and tears the surface of the layer. The structure of surface layer 2 shown in FIG. 1 is produced thereby.

In the embodiment example shown in FIG. 2, a plastic sheeting is provided, which plastic sheeting contains a base sheeting, also not visible, which base sheeting is coated with a surface layer 22. This layer 22 consists of a binder and a filler 23, which are intimately mixed on application to the base sheeting. On application, however, a concentration of the filler 23 in interrupted longitudinal streaks takes place owing to the drawing-type application.

Conversely, in the case of a differentiated application, a ramified application structure 33 is achieved within application layer 32 on plastic sheeting 31.

In the two embodiment examples shown in FIGS. 2 and 3, the binder can be applied over the entire surface or just in the area of the filler structure.

Depending on the intended purpose, corundum or silica sand is used as the filler, being used in a proportion of 20 to 70% of the total application weight.

The application weight is approximately 5 to 50 g/m² and the particle size of the filler is 40 to 250 μm.

All three embodiments result in a very high coefficient of friction for the plastic sheeting, so it can be used in numerous ways.

One possible application is in covering roof surfaces, making it possible to walk on them without a danger of slipping.

It is possible here to cover both purely timber boarding as well as viscous surfaces with the plastic sheeting.

These plastic sheetings can also be used very effectively for packaging frozen foods, since the slippage of the normally extremely smooth film packaging is effectively prevented.

It is also possible to coat the base sheeting on both sides, whereby various embodiments of the surface layers are possible.

1-11. (canceled)

12. A process for producing a plastic sheeting with a rough surface to increase the coefficient of friction, comprising
equipping at least one side of the sheeting with at least one layer which contains the rough surface,
wherein the actual plastic material sheeting and the at least one layer equipped with the rough surface is produced by the coextrusion process;
said at least one layer equipped with the rough surface is formed in the plastic material by a dissolved propellant which generates gas bubbles immediately after leaving a coextrusion nozzle, which gas bubbles despoil the at least one layer in such a way that an irregularly rough surface is produced.
